(19) United States
(12) Patent Application Publication
(10) Pub. No.: US 2022/0194393 A1
(43) Pub. Date: Jun. 23, 2022

(54) METHOD AND CONTROL UNIT FOR DETERMINING THE MASS OF A VEHICLE

(71) Applicant: ZF Friedrichshafen AG, Friedrichshafen (DE)

(72) Inventor: Manuel WENNERS, Friedrichshafen (DE)

(21) Appl. No.: 17/530,604

(22) Filed: Nov. 19, 2021

(30) Foreign Application Priority Data
Dec. 17, 2020 (DE) 10 2020 216 109.7

(51) Int. Cl. B60W 40/13; G01G 19/08

(52) U.S. Cl. CPC B60W 40/13; G01G 19/086; B60W 2520/105; B60W 2540/16; B60W 2552/30; B60W 2540/12; B60W 2520/10

(57) ABSTRACT

Method for determining the mass of a vehicle, the method having at least the following steps: at a first point in time, a first driving force and a first longitudinal vehicle acceleration are determined. At a second point in time, which is a defined interval away from the first point in time or is within a defined time interval after the first point in time, a second driving force and a second longitudinal vehicle acceleration are determined. A driving force difference is determined as a function of the first driving force and the second driving force. A longitudinal acceleration difference is determined as a function of the first longitudinal vehicle acceleration and the second longitudinal vehicle acceleration. The mass of the vehicle is determined as a function of a quotient of the driving force difference and the longitudinal acceleration difference.

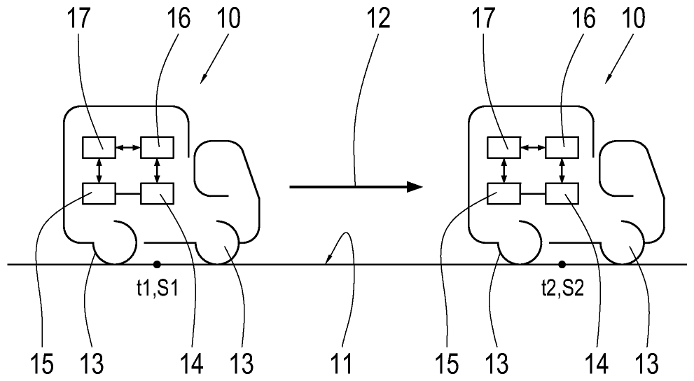

This application claims priority from German patent application serial no. 10 2020 216 109.7 filed Dec. 17, 2020.

### FIELD OF THE INVENTION

The invention relates to a method for determining the mass of a vehicle. In addition, the invention relates to a control unit for determining the mass of a vehicle.

### BACKGROUND OF THE INVENTION

From DE 198 37 380 A1 a method for determining the mass of a vehicle is known. According to the method disclosed therein, the mass of the vehicle is determined as a function of the traction force during a traction force phase, as a function of the speeds of the vehicle at the beginning and end of the traction force phase, and as a function of the speeds of the vehicle at the beginning and end of a traction-force-free phase, wherein a correction factor is taken into account which depends on the sum of the mass moments of inertia of the motor, the clutch and the transmission.

### SUMMARY OF THE INVENTION

There is a need to be able to determine the mass of a vehicle with less complexity, in particular, without the need for an incline sensor that delivers measurement values about the inclination of a road. The purpose of the present invention is to provide a new type of method and a control unit for determining the mass of a vehicle.

This objective is achieved by a method for determining the mass of a vehicle in accordance with the independent claim(s). According to the invention, the method comprises at least the following steps: a first driving force and a first longitudinal vehicle acceleration are determined at a first point in time. At a second point in time, which is a defined time interval away from the first point in time or is within a defined time interval after the first point in time, a second driving force and a second longitudinal vehicle acceleration are determined. A driving force difference is determined as a function of the said first driving force and the second driving force. A longitudinal acceleration difference is determined as a function of the first longitudinal vehicle acceleration and the second longitudinal vehicle acceleration. The mass of a vehicle is determined as a function of a quotient of the driving force difference and the longitudinal acceleration difference,.

The method according to the invention is based on the notion that when the first time point and the second time point, at which in each case a driving force and a longitudinal vehicle acceleration are determined, are a defined time interval apart, then as a function of the said driving forces and longitudinal vehicle accelerations the mass of the vehicle can be determined, and this without the need for an inclination sensor. If the interval between the time points is relatively short, it can be assumed that the inclination of a stretch of roadway between the first and second points in time does not change, so that in the determination of the mass of the vehicle the inclination can be left out of account. This enables an advantageous and simple determination of the mass of a vehicle.

Preferably, the first time point and the second time point are separated by a time interval of between 1 second and 3 seconds, in particular, between 1.5 seconds and 2 seconds. Then, if the first and second time points, at which in each case the driving force and the longitudinal vehicle acceleration are determined, are such a time interval apart, the determination of the mass can take place particularly advantageously. On the one hand, the driving force difference and the longitudinal acceleration difference should be quantitatively sufficiently large, while, on the other hand, it can be assumed that the inclination of the vehicle does not change.

Preferably, the quotient of the driving force difference and the longitudinal acceleration difference is determined cyclically, and the mass is determined as a function of an average value of the cyclically determined quotients. The mass of the vehicle can be determined particularly advantageously from such an average value formation.

Preferably, the longitudinal vehicle acceleration is determined as a function of a time gradient of a vehicle speed and/or a time gradient of a transmission output rotation speed. As a function of the gradient of the vehicle speed and/or as a function of the gradient of the transmission output rotation speed, the longitudinal vehicle acceleration can be determined advantageously.

Preferably, the mass as a function of the quotient of the driving force difference and the longitudinal acceleration difference is only determined if the driving force difference and the longitudinal acceleration difference are each quantitatively larger than a respective limit value. This can further improve the determination of the mass of the vehicle.

Preferably, the mass as a function of the quotient of the driving force difference and the longitudinal acceleration difference is only determined if, during the first point in time and during the second point in time, no gearshift and/or no braking operation and/or no driving round a curve is taking place. If, during the first point in time and during the second point in time, a gearshift and/or a braking operation and/or driving round a curve take place, then the said quotient is not used for determining the mass. This can further improve the determination of the mass of the vehicle.

Preferably, the determination of the mass of the vehicle is initialized after the vehicle has been at rest with the drive aggregate switched off or running. This is based on the recognition that when the vehicle is at rest, the mass of the vehicle can change. For example, in the case of a public-service bus, when the vehicle is traveling the number of passengers can change and so too, therefore, can the mass of the vehicle.

The control unit according to the invention for determining the mass of a vehicle is defined in the independent claim(s).

### BRIEF DESCRIPTION OF THE DRAWINGS

Preferred further developments emerge from the subordinate claims and from the description given below. Example embodiments of the invention, to which it is not limited, are explained in greater detail with reference to the drawing, which shows:

The sole Figure is an image to illustrate the method according to the invention for determining the mass of a vehicle.

### DETAILED DESCRIPTION OF THE PREFERRED EMBODIMENTS

The invention relates to a method and a control unit for determining the mass of a vehicle. The sole Figures shows a vehicle 10, very schematically, which is traveling along a road 11 in the traveling direction 12.

At a first point in time t1, the vehicle 10 is at the position S1 and at a time point t2 it is at the position S2.

The vehicle 10 has wheels 13. At least some of the wheels 13 are driven wheels. The driven wheels provide the so-termed drive output of the vehicle 10.

The vehicle 10 also comprises a drive aggregate 14 and a transmission 15. The drive aggregate 14 can be an internal combustion engine, an electric motor or even a hybrid drive. The transmission 15 can be an automatic transmission. The transmission changes rotation speeds and torques and delivers the traction force, supplied by the drive aggregate 14, to the driven wheels 13 of the vehicle 10.

The Figure also shows a motor control unit 16 and a transmission control unit 17.

The motor control unit 16 controls and/or regulates operation of the drive aggregate 14 and, for that purpose, exchanges data with the drive aggregate 14. The transmission control unit 17 controls and/or regulates operation of the transmission 15 and, for that purpose, exchanges data with the transmission 15. In addition, the motor control unit 16 and the transmission control unit 17 exchange data with one another.

In particular, now, a first driving force and a first longitudinal vehicle acceleration are determined, at a first point in time, to determine the mass of the vehicle 10. At a second point in time, which is a defined interval away from the first point in time or is within a defined time interval after the first point in time, a second driving force and a second longitudinal vehicle acceleration are determined.

The respective longitudinal vehicle accelerations can be determined as a function of a time gradient of a vehicle speed. Alternatively or in addition, the respective longitudinal vehicle accelerations can be determined as a function of a time gradient of a transmission output rotation speed, for which purpose the time gradient of the transmission output rotation speed is adjusted using an axle gear ratio of an axle carrying one of the driven wheels 13, and a dynamic tire radius of the driven wheels 13.

Furthermore, it can be provided that if the speed of the vehicle is higher than a limit value, the longitudinal vehicle acceleration is determined as a function of the time gradient of the vehicle speed, and if the speed of the vehicle is lower than the limit value, the respective vehicle acceleration is determined as a function of the time gradient of the transmission output rotation speed.

The driving force is preferably determined as a function of a drive aggregate torque, i.e., a torque produced by the drive aggregate 14. To determine the driving force, the drive aggregate torque is adjusted using the gear ratio of the transmission 15, the gear ratio of the axle carrying the driven wheels 13 and the dynamic tire radius. Preferably, the air resistance force, the acceleration force of rotating masses in the drive-train and the rolling resistance force of the vehicle are taken into account when determining the driving force. The acceleration force of the rotating masses can be calculated from the mass moments of inertia and the acceleration of the drive-train.

A driving force difference is determined as a function of the first driving force and the second driving force. A longitudinal acceleration difference is determined as a function of the first longitudinal vehicle acceleration and the second longitudinal vehicle acceleration.

A quotient is determined, which corresponds to a mass value of the vehicle, from the driving force and the longitudinal acceleration difference. The said quotient and, hence the mass value, are calculated using the following equation:

$${m}_{FZG} = \frac{{F}_{AB 2} - {F}_{AB 1}}{{a}_{L 2} - {a}_{L 1}}$$

in which

m_{FZG} is the mass value of the vehicle,

F_{AB1} is the first driving force,

F_{AB2} is the second driving force,

a_{L1} is the first longitudinal vehicle acceleration, and

a_{L2} is the second longitudinal vehicle acceleration.

The mass value, calculated using the above equation, is preferably determined cyclically or continuously, and then the mass of the vehicle is determined as a function of an average value of the cyclically or continuously determined quotient or the cyclically or continuously determined mass values.

The driving forces or driving force differences and longitudinal vehicle accelerations or longitudinal acceleration differences can be filtered.

A quotient of the driving force difference and the longitudinal acceleration difference, as calculated above, and thus a mass value of the vehicle as determined above, is only used for determining the mass of the vehicle if both the driving force difference and the longitudinal acceleration difference are, in each case, larger than a respective limit value.

Furthermore, it is provided that the above quotients of the driving force difference and the longitudinal acceleration difference are only used to determine the mass of the vehicle if, during the first time point and/or during the second time point, no gearshift in the transmission and/or no braking operation and/or no driving round a curve and/or no intervention by a driver assistance system, such as an ESP system, is in progress or taking place.

The time interval between the first time point and the second time point, at which the driving force and the longitudinal acceleration are respectively determined and which are then used to form the quotients of the driving force difference and the longitudinal acceleration difference, is preferably between 1 and 3 seconds, and, in particular, the said interval is between 1.5 and 2 seconds long.

When the time interval between the fist time point and the second time point is of that order of magnitude, it can be assumed that the inclination of the vehicle does not change. By virtue of the invention a simple and accurate determination of the mass of a vehicle is then possible, without having to know the inclination of the road.

According to an advantageous further development of the invention, it is proposed to initialize the determination of the mass of the vehicle when the vehicle is at rest with the drive aggregate switched off or running. This further development of the invention is based on the recognition that when the vehicle is at rest, its mass can change.

For example, if a public-service bus is at rest with its drive aggregate running, then it can be assumed that as the number of passengers changes, so too will the mass of the vehicle. Besides detecting that the vehicle is at rest, alternatively a door-switch signal can be taken into account when initializing the determination of the mass of the vehicle. For example, if by means of a door switch signal the opening and closing of at least one vehicle door of a public-service bus is detected, then it can also be assumed that the mass of the vehicle has changed due to a change in the number of passengers.

For example, if a furniture van is at rest with its drive aggregate switched off, it can likewise be assumed that the mass of the vehicle is changing. This also applies to other trucks and to passenger motor vehicles.

The invention also relates to a control unit, which is designed to carry out the above-described method. The said control unit is, in particular, the transmission control unit 17.

The control unit, according to the invention, comprises both hardware and software means for carrying out the method according to the invention. The hardware means include data interfaces, for example in order to exchange data for example with the motor control unit 16 which can deliver the torque of the drive aggregate. In addition, the hardware means include a processor for data processing and a memory for data storage. The software means include program modules that serve to carry out the method according to the invention.

The control unit determines driving forces and longitudinal vehicle accelerations as described above, preferably cyclically at defined points in time a defined time interval apart. As a function of corresponding driving forces and longitudinal vehicle accelerations for a first and for a second time point separated from one another by the said defined time interval, the control unit according to the invention determines, preferably cyclically, a driving force difference and a longitudinal acceleration difference, and as a function of these it determines the quotient of the driving force difference and the longitudinal acceleration difference, in order to determine the mass of the vehicle from the said quotient.

### INDEXES

10 Vehicle
11 Road
12 Travel direction
13 Wheel
14 Drive aggregate
15 Transmission
16 Motor control unit
17 Transmission control unit

1-11. (canceled)

12. A method for determining a mass of a vehicle, the method comprising:
determining a first driving force and a first longitudinal vehicle acceleration at a first point in time,
determining a second driving force and a second longitudinal vehicle acceleration at a second point in time, which second point in time is a defined time interval after the first point in time or is within a defined time interval after the first point in time,
determining a driving force difference as a function of the first driving force and the second driving force,
determining a longitudinal acceleration difference as a function of the first longitudinal vehicle acceleration and the second longitudinal vehicle acceleration, and
determining the mass of the vehicle as a function of a quotient of the driving force difference and the longitudinal acceleration difference.

13. The method according to claim 12, further comprising determining the longitudinal vehicle acceleration as a function of a time gradient of a vehicle speed.

14. The method according to claim 12, further comprising determining the longitudinal vehicle acceleration as a function of a time gradient of a transmission output rotation speed.

15. The method according to claim 13, further comprising, when the vehicle speed is higher than a limit value, determining the longitudinal vehicle acceleration as a function of a time gradient of a vehicle speed, and, when the vehicle speed is lower than the said limit value, determining the longitudinal vehicle acceleration as a function of a time gradient of a transmission output rotation speed.

16. The method according to claim 12, further comprising determining the driving force as a function of a drive aggregate torque.

17. The method according to claim 12, further determining the mass as a function of the quotient of the driving force difference and the longitudinal acceleration difference comprising only if the driving force difference and also the longitudinal acceleration difference are quantitatively larger than a respective limit value.

18. The method according to claim 12, further comprising determining the mass as a function of the quotient of the driving force difference and the longitudinal acceleration difference only if during the first time point and/or during the second time point no gearshift and/or no braking operation and/or no driving round a curve take place.

19. The method according to claim 12, further comprising separating the first time point and the second time point by a time interval of between 1 second and 3 seconds.

20. The method according to claim 12, further comprising separating the first time point and the second time point by a time interval of between 1.5 seconds and 2 seconds.

21. The method according to claim 12, further comprising determining the quotient of the driving force difference and the longitudinal acceleration difference cyclically, and determining the mass as a function of an average value of the cyclically determined quotients.

22. The method according to claim 12, further comprising initializing the determination of the mass of the vehicle after the vehicle is at rest with the drive aggregate either switched off or running.

23. The method according to claim 12, further comprising a control unit of a motor vehicle which is designed for carrying out the method.

24. The method according to claim 12, further comprising a transmission control unit which is designed for carrying out the method.
